(19) United States
(12) Patent Application Publication
(10) Pub. No.: US 2024/0100895 A1
(43) Pub. Date: Mar. 28, 2024

(54) PROVIDING AMPHIBIOUS, SUBMERSIBLE OPERATION OF AN ELECTRIC VEHICLE

(71) Applicant: Howe & Howe Inc., Waterboro, ME (US)

(72) Inventors: Anthony Victor Castro, Cape Elizabeth, ME (US); Michael Howe, Biddeford, ME (US); Todd Joey Michaud, Gorham, ME (US); William Edward McMaster, Lebanon, ME (US); Zachary Edward Sawyer, Alfred, ME (US)

(21) Appl. No.: 18/474,979

(22) Filed: Sep. 26, 2023

Related U.S. Application Data
(60) Provisional application No. 63/410,096, filed on Sep. 26, 2022.

(51) Int. Cl. B60F 3/00

(52) U.S. Cl. CPC B60F 3/0015; B60F 3/0061

(57) ABSTRACT

A technique provides an amphibious, submersible vehicle, which includes an electric drive and is capable of operating both on land and in water. The vehicle includes a water-tight compartment that houses batteries and a set of electric motors for propelling the vehicle using tracks on land and on a subsea floor. The vehicle is further capable of propelling itself through water, using the tracks and/or a set of thrusters powered by the batteries.

### CROSS-REFERENCE TO RELATED APPLICATIONS

This application claims the benefit of U.S. Provisional Application No. 63/410,096, filed Sep. 26, 2022, the contents and teachings of which are incorporated herein by reference in their entirety.

### BACKGROUND

### 1. Field

This disclosure relates generally to vehicle designs, and more particularly to an amphibious, submersible-capable electric tracked vehicle platform.

### 2. Description of Related Art

Tracked vehicles find common usage in moving equipment and/or personnel over uneven terrain or over unstable terrain, such as sand, gravel, dirt, snow, or mud. Prior tracked vehicles are normally diesel or gasoline powered.

### SUMMARY

The above-described tracked vehicles can move easily over wet ground and shallow bodies of water. Unfortunately, such vehicles are unable to operate in multiple domains, such as land, sea, and subsea. What is needed, therefore, is a vehicle that provides more flexible operation across multiple domains.

To address the above need at least in part, an improved technique provides an amphibious, submersible vehicle, which includes an electric drive and is capable of operating both on land and in water. The vehicle includes a water-tight compartment that houses batteries and a set of electric motors for propelling the vehicle using tracks on land and in some cases on a subsea floor. The vehicle is further capable of propelling itself through water, using the tracks and/or a set of thrusters powered by the batteries.

Certain embodiments are directed to an amphibious, submersible vehicle. The vehicle includes a chassis hull that includes a watertight compartment, left and right tracks disposed on left and right sides of the chassis hull and a plurality of electrical components disposed within the watertight compartment. The plurality of electrical components includes a set of electric motors and a set of batteries. The set of electric motors is configured to receive power from the set of batteries and to drive the left and right tracks, and the watertight compartment enables the vehicle to operate on land, on a water surface, or below the water surface.

In some examples, the vehicle further includes a set of thrusters at least partially disposed outside the watertight compartment at a rear of the vehicle, the set of thrusters receiving power from the set of batteries and configured to propel the vehicle both on a surface of a body of water and below the surface.

In some examples, the vehicle further includes a set of water intakes disposed at a bottom of the vehicle, the set of water intakes constructed and arranged to receive water from below the vehicle and to provide the water to the set of thrusters for ejecting the water behind the vehicle, thereby propelling the vehicle through the water.

In some examples, the set of thrusters is part of a thruster kit installed as an upgrade to the vehicle.

In some examples, the vehicle further includes a cooling system having an inlet, an outlet, and a set of radiators disposed between the inlet and the outlet. The cooling system is constructed and arranged to provide cooling for the plurality of electrical components in at least two modes, a first mode in which air flows through the set of radiators from the inlet to the outlet and a second mode in which the set of radiators is cooled through direct conduction into water surrounding the vehicle.

In some examples, the vehicle further includes a set of fans disposed between the inlet and the outlet, the set of fans constructed and arranged to blow air from the inlet to the outlet through the set of radiators.

In some examples, the inlet is disposed at a top of the vehicle and the outlet is disposed at a rear of the vehicle.

In some examples, the vehicle further includes a closed-loop cooling path formed between the plurality of electrical components and the radiator.

In some examples, the vehicle further includes skirting that at least partially covers the tracks along at least one side of the vehicle.

In some examples, the vehicle further includes armor plating attached to the skirting.

In some examples, the vehicle further includes a set of inflatable buoyancy devices attached to the skirting to enable buoyancy of the vehicle to be varied.

In some examples, the vehicle further includes a plurality of pairs of bottom wheels engaged with each track. The bottom wheels of the plurality of pairs have uniform diameter, and each pair of bottom wheels includes two bottom wheels placed side-by-side.

In some examples, the plurality of pairs of bottom wheels for each track is placed in a line such that a distance between any two consecutive pairs is less than 1.5 times the diameter of the bottom wheels.

In some examples, each of the plurality of pairs of bottom wheels is coupled to a respective suspension assembly via a respective dogleg member. Each dogleg member is coupled to the chassis hull via a hinge joint or a ball joint.

In some examples, each respective suspension assembly includes a coil-over-shock assembly.

In some examples, each coil-over shock assembly is individually tunable for providing variable stiffness.

In some examples, the vehicle further includes a first plurality of top wheels engaged with each track. One top wheel is provided for each of the plurality of pairs of bottom wheels.

In some examples, each of the plurality of pairs of bottom wheels is coupled to an axle of a respective top wheel of the first plurality of top wheels via the respective suspension assembly.

In some examples, the vehicle further includes a second plurality of top wheels engaged with each track, the second plurality of top wheels having different diameter than the first plurality of top wheels.

In some examples, each track includes a middle region from which multiple projections extend and first and second grooves disposed on respective sides of the middle region, wherein the first plurality of top wheels rides in the first groove, wherein the second plurality of top wheels rides in the second groove, and wherein the plurality of pairs of bottom wheels rides in both grooves, with one of wheel of each pair riding in the first groove and the other wheel of each pair wheels riding in the second groove.

In some examples, the vehicle further includes a deployable bow plane disposed at a front of the vehicle, the deployable bow plane including multiple panels and having a deployed position in which the panels are substantially upright and locked into place and a stowed position in which the panels are folded down and secured.

In some examples, the deployable bow plane is part of a modular nose assembly of the vehicle, the modular nose assembly being replaceable with another nose assembly having a different design.

In some examples, the vehicle further includes a flat top deck having a plurality of removeable panels and supporting the attachment of equipment thereto.

Other embodiments are directed to a method of operating an amphibious, submersible vehicle. The method includes propelling the vehicle on land using left and right tracks powered by a set of electric motors that receive electrical power from a set of batteries, the set of electric motors and the set of batteries contained within a watertight compartment of a chassis hull of the vehicle. The method further includes propelling the vehicle in a body of water using a set a set of thrusters powered by the set of electric motors, the set of thrusters receiving water from outside the vehicle and ejecting the water behind the vehicle.

In some examples, propelling the vehicle in the body of water is further performed using the left and right tracks.

In some examples, the method further includes propelling the vehicle on a floor of the body of water using the left and right tracks powered by the set of electric motors but not using the set of thrusters.

In some examples, the method further includes deploying a bow plane disposed at a front of the vehicle and propelling the vehicle on a surface of the body of water using the set of thrusters.

In some examples, the method further includes cooling the set of electric motors and the set of batteries using ambient air when propelling the vehicle on land; and cooling the set of electric motors and the set of batteries using ambient water when propelling the vehicle in the body of water.

In some examples, the method further includes varying a buoyancy of the vehicle when propelling the vehicle in the body of water.

In some examples, the method further includes driving the vehicle into the body of water such that the vehicle is completely submerged, placing the vehicle in a standby mode, in which the vehicle is quiescent, and upon receiving an instruction to deploy, exiting the standby mode and driving the vehicle out of the body of water and onto adjacent land.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is an upper-left isometric view of an example amphibious, submersible electric vehicle in accordance with certain embodiments.

FIG. 2 is a top view thereof, with certain components removed.

FIG. 3 is an elevated left view thereof.

FIG. 4 is an elevated right view thereof, showing certain optional components.

FIG. 5 is an elevated front view thereof.

FIG. 6 is an elevated rear view thereof.

FIG. 7 is a top view thereof.

FIG. 8 is a bottom view thereof.

FIG. 9 is a flowchart showing an example method of operating an amphibious, submersible vehicle.

FIG. 10 is a flowchart showing an example mission procedure for an amphibious, submersible vehicle.

### DETAILED DESCRIPTION

Embodiments of the improved technique will now be described. One should appreciate that such embodiments are provided by way of example to illustrate certain features and principles but are not intended to be limiting.

An improved technique provides an amphibious, submersible vehicle, which includes an electric drive and is capable of operating both on land and in water. The vehicle includes a water-tight compartment that houses batteries and a set of electric motors for propelling the vehicle using tracks on land and on a subsea floor. The vehicle is further capable of propelling itself through water, using the tracks and/or a set of thrusters powered by the batteries.

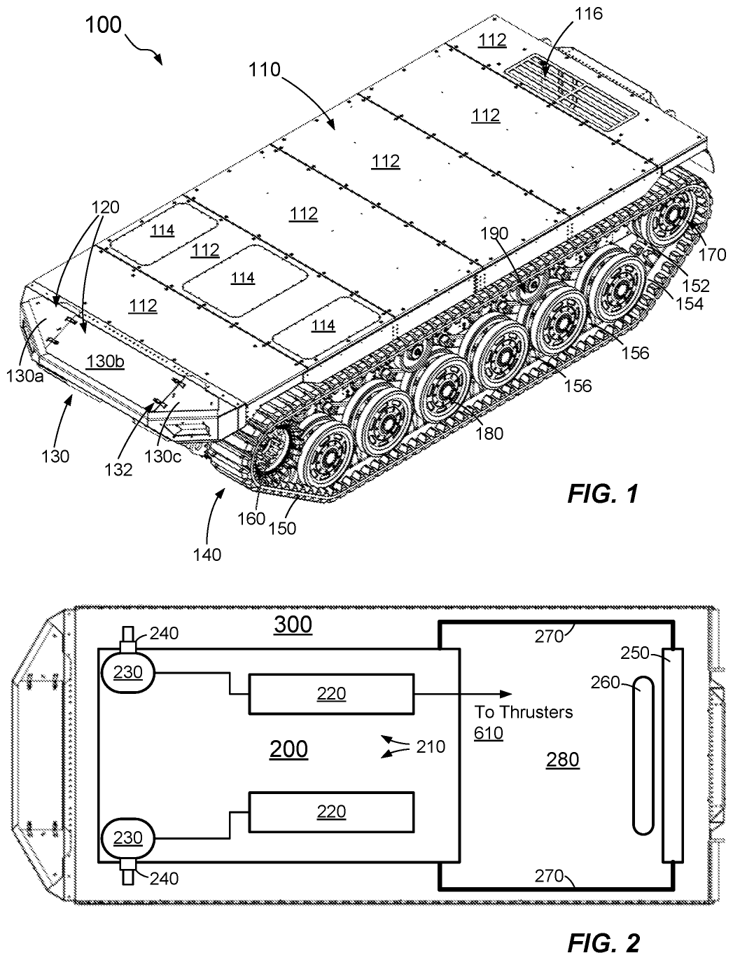

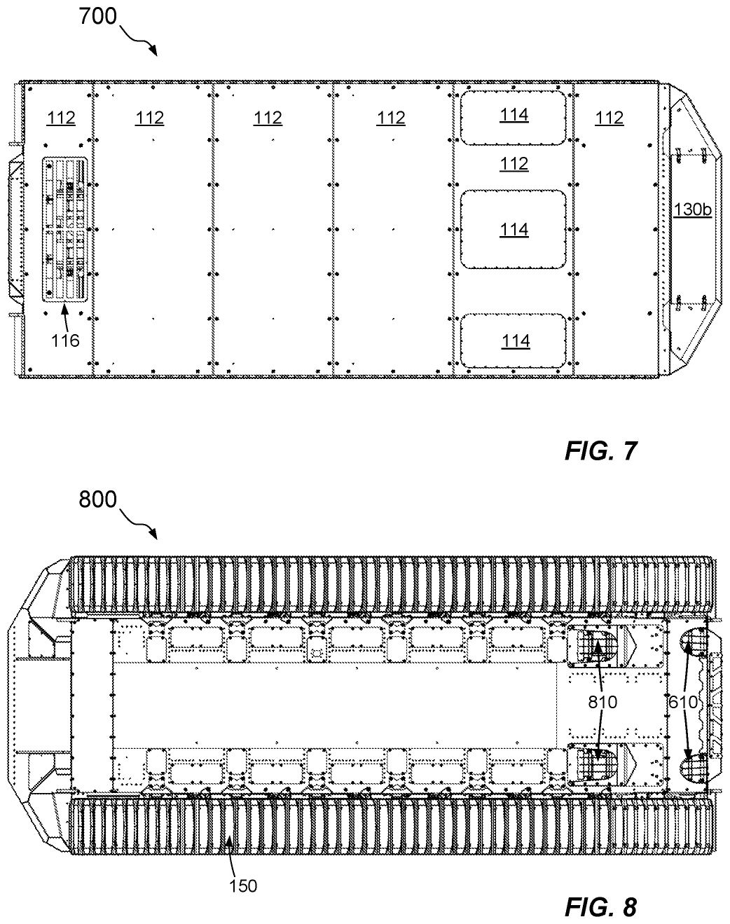

FIGS. 1-8 shows an example amphibious, submersible vehicle 100 (the “vehicle”) in accordance with certain embodiments. The vehicle 100 may be provided as a remote-controllable vehicle or an autonomous vehicle, for example. The vehicle may also be controlled by an operator positioned on or within the vehicle 100, however.

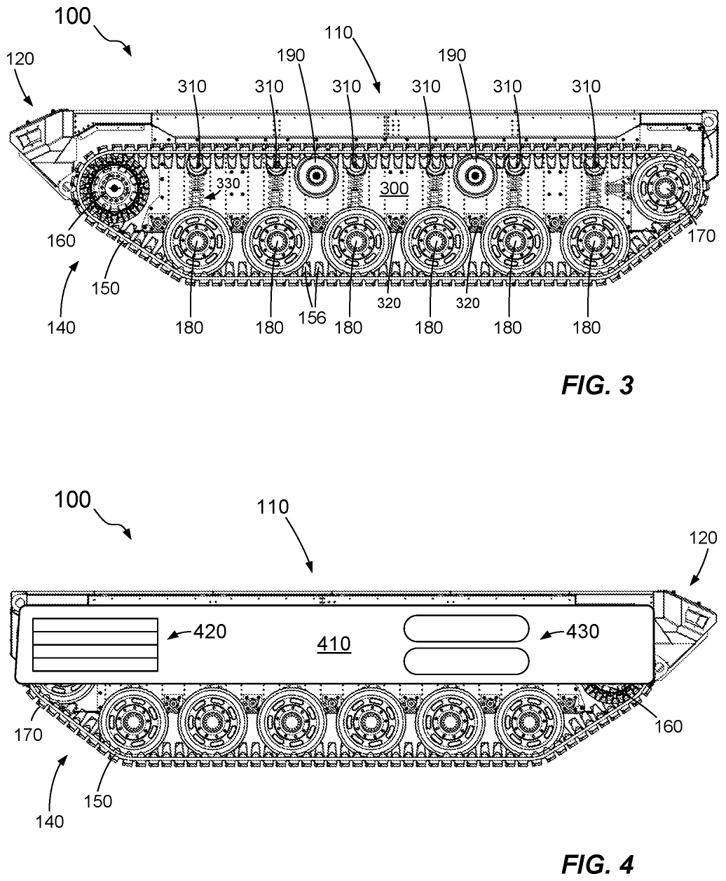

The vehicle 100 includes a chassis hull 300 (see the middle of FIG. 3), also referred to herein as a “body” of the vehicle 100. For example, the chassis hull 300 may have a substantially cuboid shape, which provides an enclosure for components and a structure to which other components and assemblies attach. Such other components and assemblies include a flat top deck 110, a nose piece 120, left and right suspension carriers 140 for driving respective tracks 150.

The flat top deck 110 is mounted to the top of the chassis hull 300. In an example, the flat top deck 110 includes multiple panels 112 for mounting equipment. For example, a panel 112 can be removed, revealing a hole pattern and/or other mounting hardware for attaching external equipment. In addition, one or more top panels 112 may include an externally-accessible hole pattern for receiving nuts and bolts directly, for example, to enable equipment to be attached directly to the top deck 110 without having to remove any panels 112. A variety of types of equipment may be attached to the top deck 110, including sensors, antennas, munitions, and communications equipment, for example. The top deck 110 may also include one or more access panels 114, e.g., for providing access to serviceable equipment within the vehicle, spare parts, and/or stored supplies.

As best seen in FIG. 1, the nose piece 120 includes a deployable bow plane 130, which includes panels 130a, 130b, and 130c. In an example, the panels are individually hinged at their respective front edges for folding up to assume a deployed position or for folding down for assuming a stowed position in which the panels are locked in place, e.g., using the illustrated latches 132. In the deployed position, the panels are substantially upright and locked into place. In some examples, the panels in the upright position are slanted forward, such as at an angle between 30 degrees and 60 degrees from vertical. The deployable bow plane 130 may be operated manually or automatically, e.g., by operation of one or more electric motors that respond to electronic commands from a controller.

The nose piece 120 may be provided as a modular assembly, which may be removed from the vehicle and replaced with another nose assembly having a different design. For example, the depicted nose piece 120 may be replaced with another one having one or more cameras or other sensors, but not having a deployable bow plane.

As further shown, each of the suspension carriers 140 includes a drive sprocket 160, which includes teeth for engaging a respective track 150 and which is turned by an electric motor inside the chassis hull 300. The track 150 is this made to travel around the suspension carrier 140 as the drive sprocket 160 rotates. The suspension carrier 140 further includes a tensioner wheel 170, which may be adjusted forward and back to adjust tension on the track 150. The suspension carrier 140 may further include bottom wheels 180 and top wheels 190. In addition, the track 150 may have inwardly-facing features that promote engagement with the wheels. These include first and second grooves 152 and 154, respectively, within which the wheels ride, and a middle region having upward projections 156, which assist in keeping the track 150 aligned with the wheels.

FIG. 2 shows an example schematic arrangement of components within the chassis hull 300. These include a watertight compartment 200 that houses a plurality of electrical components 210, such as battery packs 220 and electric motors 230, keeping these components dry. Although the watertight compartment 200 is shown as a single region, it may alternatively include any number of water-tight sub-compartments, which may be contiguous or separate. For vehicles equipped with thrusters 610 (FIG. 6), the electrical components 210 may further include certain portions of the thrusters (e.g., motor, motor controller, etc.), which may be physically located within the watertight compartment 200. In such examples, an inlet plenum and tunnel may create a watertight boundary and contain the thruster gearbox and propeller.

In the depicted arrangement, two battery packs 220 are provided, one for each electric motor 230, but this is merely an example. For instance, a single battery pack 220 could be used for both motors 230. In addition, battery packs 220 may be arranged in any suitable way, such as in parallel, in series, or in any suitable combination.

In an example, each electric motor 230 has an associated gearbox 240, which extends from inside the sealed compartment 300 to outside the sealed compartment 300, where a drive shaft of the gearbox engages a respective drive sprocket 160. In an example, each gearbox 240 is designed to operate without leaking to a specified depth within water, which depth includes a desired range of operation of the vehicle 100.

As further shown in FIG. 2, the chassis hull 300 houses a set of radiators 250 and an associated set of fans 260, which are configured to blow air through the set of radiators 250 when the vehicle 100 is operating on land. The set of fans 260 receives electrical power from the set of battery packs 220. When operating in water, the set of fans 260 may be disabled and cooling is achieved instead through direct conduction from the set of radiators 250 into water, e.g., the water surrounding the vehicle. The set of radiators 250 is coupled to the electrical components 210 via cooling lines 270, which circulate a coolant, such as glycol-based antifreeze, around a closed-loop path 280 between the set of radiators 250 and the electrical components 210.

In some examples (not shown), two separate cooling loops are provided, a first cooling loop for cooling a left motor of the vehicle (and optionally associated batteries and electronics) and a second cooling loop for cooling a right motor of the vehicle (and optionally associated batteries and electronics). In an example, each cooling loop has its own radiator and cooling pump. In an example, the two cooling loops may share a common coolant reservoir.

In some examples, the vehicle includes a cooling an inlet 116 disposed at a top of the vehicle (FIG. 1) and a cooling outlet 620 disposed at a rear of the vehicle (FIG. 6). Alternatively, the inlet 116 and outlet 620 may be located elsewhere on the vehicle, such as on the sides. The set of radiators 250 is disposed in an airflow path between the inlet 116 and the outlet 620. When operating on land, ambient air flows through the set of radiators 250 from inlet to outlet. When operating in water, ambient water enters the chassis hull 300 from the outlet 620 (or inlet 116) and comes in contact with the set of radiators 250, cooling them by direct conduction.

FIG. 3 shows a left-side view of the vehicle 100, revealing additional details of the suspension carrier 140. Here, the suspension carrier 140 is seen to include a plurality of pairs of bottom wheels 180 (six pairs shown). The bottom wheels 180 of each pair have a diameter, and the pairs are placed in a line such that, in some examples, a distance between two consecutive pairs of bottom wheels is less than 1.5 times the diameter. Close spacing of pairs of bottom wheels 180 helps to resist detracking, which can be particularly troublesome when the vehicle 100 is operating in water. In an example, each of the plurality of pairs of bottom wheels is coupled to a respective suspension assembly 330 (e.g., a coil-over-shock assembly) via a respective dogleg member 320, which in turn is coupled to the chassis hull 300 via a hinge joint or a ball joint. In an example, each dogleg member 320 is a straight member, e.g., composed of square metal tubing, which runs from the hinge joint or ball joint (shown to the upper-left of each dogleg member) and the axle of a respective pair of bottom wheels 180.

In some examples, the vehicle includes multiple top wheels in contact with a track. In some examples, the top wheels include a first plurality of wheels 310, e.g., one top wheel 310 for each pair of bottom wheels 180. In an example, each coil-over-shock assembly 330, which is provided for a respective one of the plurality of pairs of bottom wheels 180, terminates at a respective top wheel 310 of the first plurality of wheels. For example, each coil-over shock 330 assembly terminates in a respective ball joint, which is secured to the chassis hull 300 via a shaft that also forms an axle of a respective wheel 310. This arrangement saves space and parts, and it avoids the need to make special provisions for clearance between the track 150 and the suspension components (as sufficient clearance is guaranteed by design). Although coil-over-shock assemblies are particularly suitable, alternatives may be used instead, such as hydraulic struts or torsion bars.

In some examples, the top wheels further include a second plurality of wheels 190. In an example, each of the second plurality of wheels 190 is larger in diameter than any of the above-described first plurality of wheels 310. As described in connection with FIG. 1, the track 150 includes an inner flat region 152, closer to the body of the vehicle, an outer flat region 154, farther from the body of the vehicle, and a middle region between the inner and outer regions. The middle region has multiple projections 156, referred to herein as “shark fins.” In an example, each of the second plurality of wheels 190 rides within the outer flat region 154, while each of the first plurality of wheels 310 rides within the inner flat region 152. The described arrangement of top wheels helps to keep the track 150 properly centered and resists detracking. It also prevents the track 150 from sloping inwardly or outwardly as it rides along the top of the suspension carrier 140. One should appreciate that the sizes of the wheels can be varied to suit different geometries and spacing constraints. For example, the wheels in the first plurality and second plurality can be the same size in certain designs, or the sizes can be reversed. Many arrangements are contemplated.

In some examples, the coil-over-shock assemblies 330 are individually tunable for providing variable stiffness. For example, shocks near the front and back of the vehicle may be adjusted to be stiffer than shocks in the middle, to resist pitching of the vehicle associated with fast acceleration and/or braking. Alternatively, shocks closer to the middle may be made stiffer to support turning in place. Adjustments can be achieved by swapping certain shocks with other shocks in the vehicle, or by adjusting shocks individually, e.g., by configuring desired preloads.

FIG. 3 shows a right-side view of vehicle 100. Typically, the left and right sides of the vehicle 100 are mirror images. They are shown as different here to illustrate the optional inclusion of skirting 410 (which may be provided on one or both sides). In an example, skirting 410 at least partially covers the suspension carrier 140 and helps to reduce drag when operating the vehicle 100 in water.

In some examples, the skirting provides an attachment surface for various equipment, such as armor plating 420 and/or buoyancy devices 430, such as balloons, bladders, and the like. In some examples, the skirting 410 itself provides armor plating, such that separate armor plating 420 is not needed. The buoyancy devices 430 may be inflatable or hard (fixed dimensions). In some examples, the buoyancy devices enable buoyancy of the vehicle to be varied, e.g., under electronic control by an operator. For instance, when the vehicle 100 is floating on a water surface, a water level is established below a top of the outlet 620, such that an airflow path can be maintained from inlet to outlet.

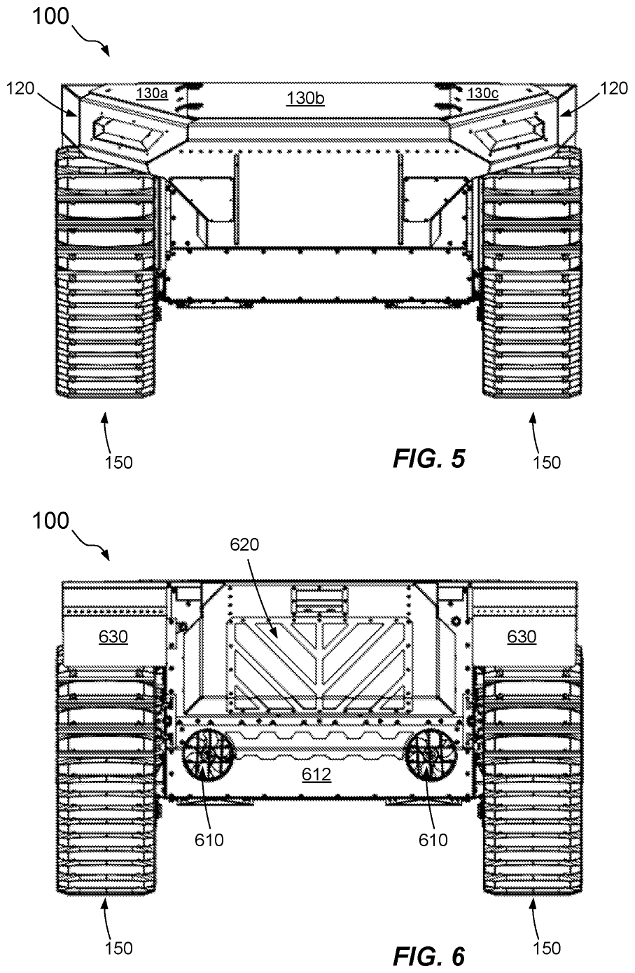

FIGS. 5 and 6 show front and rear view of the vehicle 100. As shown in FIG. 6, the vehicle 100 includes a set of thrusters 610, such as one or more propellers) at the rear of the vehicle, for propelling the vehicle 100 while it is being driven on a water surface and/or below the water surface (swimming). The thrusters 610 (two thrusters shown) are provided on a thruster plate 612 and may be powered by one or more of the battery packs 220 (FIG. 2). The vehicle 100 may also include mud flaps 630.

In some examples, the set of thrusters 610 is part of a thruster kit, which may be provided as an upgrade for the vehicle 100 and which may be removed from the vehicle and replaced, for example, by a cover plate if the set of thrusters is no longer needed.

As shown in FIG. 8, the vehicle includes a set of water intakes 810 disposed at a bottom of the vehicle for providing water to the set of thrusters 610. In some examples, the set of thrusters 610 may be inactive when the vehicle is driving on the floor of a body of water, with propulsion instead provided via the tracks 150. Using the tracks 150 rather than the thrusters 610 effectively moves the vehicle 100, which generally maintains good traction with the floor, while disabling the thrusters 610 prevents drawing mud and other debris into the water intakes 810, obscuring the scene (from the viewpoint of operators or cameras) and contributing to damage or wear of the thrusters 610. However, some subsea driving scenarios employ both the tracks and thrusters, or only the tracks. Operators thus have great flexibility in controlling subsea operation.

The amphibious, submersible vehicle 100 as described herein is capable of operating on land as well as on a surface of a body of water, below the surface of the body of water, and/or on the floor of the body of water. When operating on land, the vehicle 100 is propelled using the tracks 150. When operating in water or on the surface of water, the vehicle 100 is propelled using the thrusters 610. When operating on a sea floor, the vehicle 100 is propelled using the tracks 150 and/or the thrusters 610, as circumstances require.

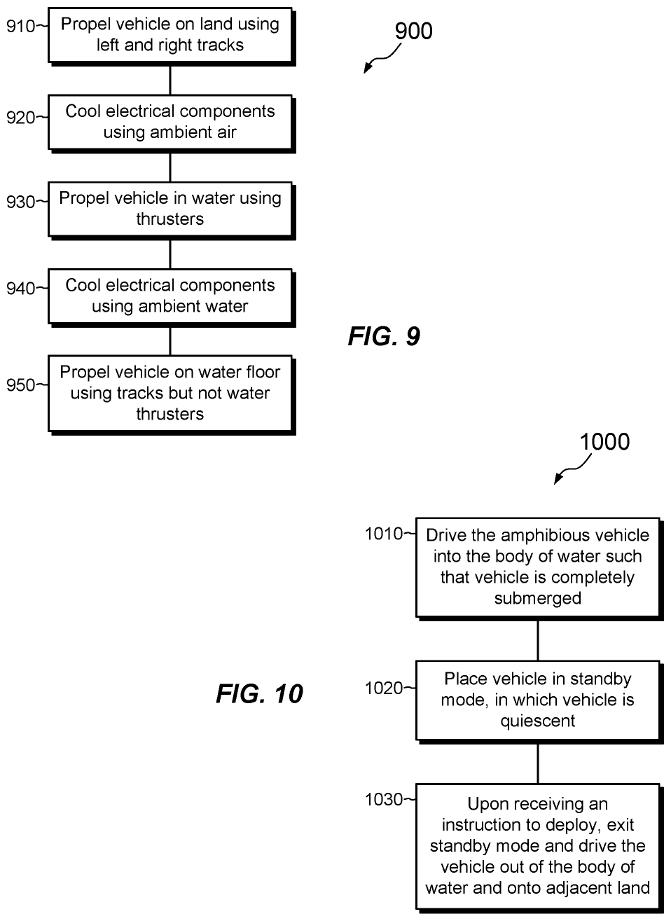

FIG. 9 shows an example method 900 of operating an amphibious, submersible vehicle 100. The acts of method 900 may be performed, for example, by the vehicle itself, either independently or under control of an operator, which may be a human user or a software application.

At 910, the vehicle 100 is propelled on land using left and right tracks 150. For example, the vehicle may be driven forward and reverse by directing the set of electric motors 230 to turn in respective directions. The vehicle 100 also supports skid steering, i.e., when the two tracks are driven at different speeds and/or in different directions.

At 920, with the vehicle being driven on land, electronic components 210 of the vehicle 100 are cooled using ambient air, e.g., by activating the set of fans 260 to blow air through the set of radiators 250 from inlet 116 to outlet 620.

At 930, the vehicle 100 is propelled in water using the set of thrusters 610. In this mode, the electric motors 230 may be disabled, stopping the tracks 150, with power from the set of batteries 220 instead used to power to the thrusters 610. In this mode, the vehicle 100 may be floating on the surface of a body of water, or it may be entirely submerged and “swimming” within the water.

At 940, while floating or swimming, the electrical components 210 are cooled by direct conduction into surrounding water. For example, water enters the outlet 610 and/or the inlet 116 and reaches the set of radiators 250, which transfers heat into the water. In some examples, air cooling may be used while the vehicle is floating, provided that neither the inlet 116 nor the outlet 620 is blocked by water and provided that the set of fans 260 is clear of the water and free to turn. Alternatively, depending on the placement of radiator(s) and fans and on the water level, water cooling may be used instead of air cooling while the vehicle is floating.

At 950, the vehicle 100 is propelled on the floor of the body of water using the tracks 150 but not using the thrusters 610. For example, the vehicle drives on the floor the same way it drives on land. In some examples, depending on circumstances, the thrusters 610 may also be used on the sea floor, either as the sole means of propulsion or in combination with the tracks 150.

FIG. 10 shows an example mission procedure 1000 for an vehicle 100. The procedure 1000 may be performed by the vehicle itself, e.g., under control of an operator or autonomously.

At 1010, the vehicle 100 is driven into a body of water and completely submerged, preferably so that it is out of sight and not easily identified from above, e.g., by reconnaissance aircraft.

At 1020, the vehicle 100 is placed in a standby mode, e.g., in which the vehicle operates silently in a low-power state. The vehicle can remain in this state for an indefinite period of time, which may be limited only by available battery power.

At 1030, upon receiving (or autonomously generating) an instruction to deploy, the vehicle 100 exits the standby mode and drives out of the body of water and onto adjacent land, where it may proceed to perform further functions of the mission. In some examples, the vehicle may be equipped with a deployable antenna, which can float on the surface to facilitate wireless communication with a base station, which may be arbitrarily far away. The instruction to deploy can thus be received from any arbitrary distance.

An improved technique has been described for an amphibious, submersible vehicle 100, which includes an electric drive and is capable of operating both on land and in water. The vehicle includes a water-tight compartment that houses batteries and a set of electric motors for propelling the vehicle using tracks on land and in some cases on a subsea floor. The vehicle is further capable of propelling itself through water, using the tracks and/or a set of thrusters powered by the batteries.

Having described certain embodiments, numerous alternative embodiments or variations can be made. For example, although embodiments have been described in connection to tracked, electric vehicles, other embodiments may be realized that do not use tracks and/or do not require electric operation.

Further, although embodiments have been described that enable operation on land, on the surface of a body of water, under water, and on the floor of the body of water, embodiments are not required to operate in all of four domains.

Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

Table of Reference Numerals:

| Reference | |
|---|---|
| Numeral | Description |
| 100 | Amphibious electric tracked vehicle |
| 110 | Top deck, including removable panels 112 and |
| | access panels 114 |
| 112 | Removeable panels |
| 114 | Access panels |
| 116 | Radiator inlet |
| 120 | Removeable nose piece |
| 130, 130a, | Deployable bow plane, e.g., including three panels, |
| 130b, 130c | 130a, 130b, and 130c, which may be |
| | individually hinged in front for folding up to |
| | assume deployed position and locking in place |
| 132 | Latches, e.g., buckle latches, for securing panels |
| | in stowed position |
| 140 | Suspension carrier |
| 150 | Track |
| 152 | Inner flat region |
| 154 | Outer flat region |
| 156 | Shark fin |
| 160 | Drive sprocket |
| 170 | Tensioner wheel |
| 180 | Bottom wheel (provided in a pair, |
| | with shark fin passing between). |
| 190 | Large top wheels (second plurality of wheels); |
| | rides in outer flat region |
| 200 | Watertight compartment |
| 210 | Electrical components |
| 220 | Battery packs |
| 230 | Electric motors |
| 240 | Gearbox, e.g., sealed to prevent water intrusion |
| | into watertight compartment |
| 250 | Radiator(s) |
| 260 | Fan(s) |
| 270 | Coolant lines, forming closed-loop cooling path |
| 280 | Closed-loop cooling path |
| 300 | Chassis hull, i.e., body of vehicle |
| 310 | Small top wheels (first plurality of wheels); |
| | ride in inner flat region |
| 320 | Dogleg (attaches bottom wheel to body). |
| 330 | Suspension, e.g., coil-over-shock; e.g., |
| | each shock terminates in respective wheel 310 |
| | and fastens to body via axle of wheel |
| 410 | Skirting, e.g., for reducing drag within water and providing |
| | attachment surface for armor and/or buoyancy device(s). |
| 420 | Armor plates |
| 430 | Variable buoyancy devices |
| 610 | Thruster (e.g., propeller) |
| 612 | Thruster panel (may optionally be replaced by blank panel) |
| 620 | Radiator outlet (one or more radiators may be placed |
| | between inlet and outlet) |
| 630 | Mud flaps |
| 700 | Top of vehicle |
| 800 | Bottom of vehicle |
| 810 | Water intakes for propellers |

What is claimed is:

1. An amphibious, submersible vehicle, comprising:
a chassis hull that includes a watertight compartment;
left and right tracks disposed on left and right sides of the chassis hull; and
a plurality of electrical components disposed within the watertight compartment, the plurality of electrical components including a set of electric motors and a set of batteries, the set of electric motors configured to receive power from the set of batteries and to drive the left and right tracks, the watertight compartment enabling the vehicle to operate on land, on a water surface, or below the water surface.

2. The vehicle of claim 1, further comprising a set of thrusters at least partially disposed outside the watertight compartment at a rear of the vehicle, the set of thrusters receiving power from the set of batteries and configured to propel the vehicle both on a surface of a body of water and below the surface.

3. The vehicle of claim 2, further comprising a set of water intakes constructed and arranged to receive water from outside the vehicle and to provide the water to the set of thrusters for ejecting the water behind the vehicle, thereby propelling the vehicle through the water.

4. The vehicle of claim 3, wherein the set of thrusters is part of a thruster kit installed as an upgrade to the vehicle.

5. The vehicle of claim 1, further comprising:
a cooling system having an inlet, an outlet, and a set of radiators disposed between the inlet and the outlet, the cooling system constructed and arranged to provide cooling for the plurality of electrical components in at least two modes, a first mode in which air flows through the set of radiators from the inlet to the outlet and a second mode in which the set of radiators is cooled through direct conduction into water surrounding the vehicle.

6. The vehicle of claim 5, further comprising a set of fans disposed between the inlet and the outlet, the set of fans constructed and arranged to blow air from the inlet to the outlet through the set of radiators.

7. The vehicle of claim 6, wherein the inlet is disposed at a top of the vehicle and the outlet is disposed at a rear of the vehicle.

8. The vehicle of claim 5, further comprising a closed-loop cooling path formed between the plurality of electrical components and the radiator.

9. The vehicle of claim 1, further comprising skirting that at least partially covers the tracks along at least one side of the vehicle.

10. The vehicle of claim 9, wherein the skirting includes armor plating.

11. The vehicle of claim 8, further comprising a set of buoyancy devices attached to or integral with the skirting to enable buoyancy of the vehicle to be varied.

12. The vehicle of claim 1, further comprising a plurality of pairs of bottom wheels engaged with each track, the bottom wheels of the plurality of pairs having uniform diameter, and each pair of bottom wheels including two bottom wheels placed side-by-side.

13. The vehicle of claim 12, wherein the plurality of pairs of bottom wheels for each track is placed in a line such that a distance between any two consecutive pairs is less than 1.5 times the diameter of the bottom wheels.

14. The vehicle of claim 12, wherein each of the plurality of pairs of bottom wheels is coupled to a respective suspension assembly via a respective dogleg member, each dogleg member coupled to the chassis hull via a hinge joint or a ball joint.

15. The vehicle of claim 14, wherein each respective suspension assembly includes a coil-over-shock assembly.

16. The vehicle of claim 15, wherein each coil-over shock assembly is individually tunable for providing variable stiffness.

17. The vehicle of claim 14, further comprising a first plurality of top wheels engaged with each track, one top wheel for each of the plurality of pairs of bottom wheels.

18. The vehicle of claim 17, wherein each of the plurality of pairs of bottom wheels is coupled to an axle of a respective top wheel of the first plurality of top wheels via the respective suspension assembly.

19. The vehicle of claim 17, further comprising a second plurality of top wheels engaged with each track, the second plurality of top wheels having different diameter than the first plurality of top wheels.

20. The vehicle of claim 19, wherein each track includes a middle region from which multiple projections extend and first and second grooves disposed on respective sides of the middle region, wherein the first plurality of top wheels rides in the first groove, wherein the second plurality of top wheels rides in the second groove, and wherein the plurality of pairs of bottom wheels rides in both grooves, with one of wheel of each pair riding in the first groove and the other wheel of each pair wheels riding in the second groove.

21. The vehicle of claim 1, further comprising a deployable bow plane disposed at a front of the vehicle, the deployable bow plane including multiple panels and having a deployed position in which the panels are substantially upright and locked into place and a stowed position in which the panels are folded down and secured.

22. The vehicle of claim 21, wherein the deployable bow plane is part of a modular nose assembly of the vehicle, the modular nose assembly being replaceable with another nose assembly having a different design.

23. The vehicle of claim 1, further comprising a flat top deck having a plurality of removeable panels and supporting the attachment of equipment thereto.

24. A method of operating an amphibious, submersible vehicle, comprising:
propelling the vehicle on land using left and right tracks powered by a set of electric motors that receive electrical power from a set of batteries, the set of electric motors and the set of batteries contained within a watertight compartment of a chassis hull of the vehicle; and
propelling the vehicle in a body of water at least in part using a set a set of thrusters powered by the set of electric motors, the set of thrusters receiving water from outside the vehicle and ejecting the water behind the vehicle.

25. The method of claim 24, wherein propelling the vehicle in the body of water is further performed using the left and right tracks.

26. The method of claim 24, further comprising propelling the vehicle on a floor of the body of water using the left and right tracks powered by the set of electric motors but not using the set of thrusters.

27. The method of claim 24, further comprising:
deploying a bow plane disposed at a front of the vehicle; and
propelling the vehicle on a surface of the body of water using the set of thrusters.

28. The method of claim 24, further comprising:
cooling the set of electric motors and the set of batteries using ambient air when propelling the vehicle on land; and
cooling the set of electric motors and the set of batteries using ambient water when propelling the vehicle in the body of water.

29. The method of claim 24, further comprising varying a buoyancy of the vehicle when propelling the vehicle in the body of water.

30. The method of claim 24, further comprising:
driving the vehicle into the body of water such that the vehicle is completely submerged;
placing the vehicle in a standby mode, in which the vehicle is quiescent; and
upon receiving an instruction to deploy, exiting the standby mode and driving the vehicle out of the body of water and onto adjacent land.
